(19) United States
(12) Patent Application Publication
(10) Pub. No.: US 2021/0186794 A1
(43) Pub. Date: Jun. 24, 2021

(54) Device and Method for Passive Tactile Stimulation

(71) Applicant: Georgia Tech Research Corporation, Atlanta, GA (US)

(72) Inventors: Caitlyn Seim, Atlanta, GA (US); Thad Eugene Starner, Atlanta, GA (US)

(21) Appl. No.: 16/650,154

(22) PCT Filed: Sep. 26, 2018
(86) PCT No.: PCT/US18/52918

§ 371 Date: Mar. 24, 2020

Related U.S. Application Data
(60) Provisional application No. 62/563,279, filed on Sep. 26, 2017.

(51) Int. Cl. A61H 1/02; A61H 23/02

(52) U.S. Cl. CPC A61H 1/0274; A61H 23/0254; A61H 2205/065; A61H 2201/165; A61H 2201/0157

(57) ABSTRACT

Systems, devices, and methods disclosed herein can generally include passive tactile stimulation (“PTS”) for rehabilitation of neurological conditions, conditions resulting from stroke, conditions resulting from brain damage, tremors resulting from Parkinson's disease, cardiovascular disorder, spatial neglect, sensitivity loss, and/or muscle spasticity. Devices can be worn or applied during daily life and can be effective treatment for aforementioned conditions without a patent engaging in exercises, forced muscle contraction due to electrostimulation or repeated muscle vibration, or even focusing on the stimulation treatment.

### CROSS-REFERENCE TO RELATED APPLICATIONS

This Application claims priority under 35 U.S.C. § 119(e) to U.S. Provisional Patent Application No. 62/563,279, “Device and Method for Passive Tactile Stimulation” filed Sep. 26, 2017, which is hereby incorporated by reference herein in its entirety as if fully set forth below.

### STATEMENT REGARDING FEDERALLY SPONSORED RESEARCH

This invention was made with government support under NSF contract #IIS1217473, awarded by the National Science Foundation. The government has certain rights in the invention.

### BACKGROUND OF THE INVENTION

This disclosure relates generally to treatment of neurological conditions, and more particularly to applying passive tactile stimulation for treatment of neurological conditions.

Stroke is the leading cause of serious, long-term disability in the United States, and about half of patients suffering a stroke are left disabled, never fully recovering from the stroke. Stroke can result in loss in functionality and/or sensation in portions or throughout the half of the body opposite the affected brain hemisphere. A stroke can happen to anyone, at any time, at any age including teenagers, children, and newborns. On average, in the United States a person has a stroke about once every 40 seconds. Worldwide, the average occurrence of strokes is approximately 30 incidences of stroke every 60 seconds, with approximately 16.9 million strokes occurring in 2010 worldwide. In 2010, the estimated global cost of treatment of stroke related ailment was $863 billion, and the cost is expected to rise to $1044 billion by 2030. In addition to stroke, other neurological conditions such as Parkinson's, traumatic brain injury, Multiple Sclerosis, and Cerebral Palsy can result in spasticity (“tone”), unilateral spatial neglect, essential tremor, or other neurological loss of functionality and/or sensation.

The current primary treatment for neurological conditions is Constraint-induced Movement Therapy (“CIMT”), a specialized rehabilitation therapy wherein a patient engages in daily directed rehabilitation of an affected limb and the patient's dominant limb is restricted during daily activities. An object of the treatment is to cause the brain to grow new neural pathways as a result of the concentrated use of the affected limb to increase functionality of the affected limb.

CIMT and similar treatments of repeated exercise are highly specialized for each patient with targeted treatments to improve coordination, movement, strength, and flexibility of affected limbs based on the needs and abilities of each patient. CIMT is typically an in-patient program requiring skilled teams of therapists and doctors for developing and administering rehabilitation programs. CIMT and similar treatments are also use-dependent (i.e., the more time spent in a rehabilitation program, the more effective the treatment).

Although programs vary, CIMT programs typically can involve several hours of concentrated therapy per day, at least five days a week, for approximately two weeks. As part of the CIMT treatment, patients also are instructed to wear specialized equipment on their dominant limb during about 90% of their waking hours to encourage use of the affected limb while not in active therapy. In general, CIMT treatment can be more effective the more restricted the dominant limb is, but concerns for patient safety may require that the dominant limb is less restricted or restricted for fewer hours of the day for a particular CIMT regimen.

Due to the expense, time, difficulty, and need for rigorous participation on the part of both the patient and clinicians, CIMT and similar exercise-based treatments are not easily accessible or equally affective for all stroke victims. Furthermore, participation in the CIMT treatments requires a certain amount of baseline dexterity, and up to 50% of stroke survivors lack sufficient dexterity to benefit from CIMT treatments.

Additionally, CIMT treatments are designed primarily to increase functionality of affected upper limbs, and CIMT is generally not a treatment for increasing functionality of the lower limbs or other parts of the body, for correcting sensory loss, for treating Unilateral Spatial Neglect (“USN”), or for reducing involuntary muscle contraction. Current therapy options targeting conditions other than upper limb functionality are few and not widely used clinically.

Electrostimulation is an alternative treatment to exercise-based therapies that involves electrical stimulation of muscles to force muscle contractions. But electrostimulation is not an ideal treatment because it is invasive, obtrusive, not mobile, and can be painful.

Repeated muscle vibration (“rVM”) is another form of forced muscle stimulation, wherein a patient lays prone in a lab and has targeted muscle stimulation via a vibrating pin. And while rVM has been experimentally investigated as a potential treatment for spasticity and cortical excitability, it likewise is not ideal because it is cumbersome, transient, costly, and experimental/rare.

Vibration of the left posterior neck muscles has been experimentally investigated as a treatment for forms spatial neglect at least as early as 1993 based on a model of the mechanisms leading to spatial neglect that assumes the central transformation of afferent sensory information (from the retina, neck muscle spindles, vestibular organs) into non-retinal spatial reference systems to be distributed. Such treatment is still considered experimental and has yet to become clinically approved. Further, vibration of the left posterior neck muscles only had been investigated in relation to treating spatial neglect and has not been investigated as a treatment for other neurological disorder symptoms including limb functionality or regaining sensation.

There is therefore a need for improved methods and devices for treating patents having a neurological condition.

### BRIEF SUMMARY OF THE INVENTION

Systems, devices, and methods disclosed herein can generally include passive tactile stimulation (“PTS”) for rehabilitation of neurological conditions, conditions resulting from stroke, conditions resulting from brain damage, tremors resulting from Parkinson's disease, cardiovascular disorder, spatial neglect, sensitivity loss, and/or muscle spasticity. Devices can be worn or applied during daily life and can be effective treatment for aforementioned conditions without a patent engaging in exercises, forced muscle contraction due to electrostimulation or repeated muscle vibration, or even focusing on the stimulation treatment.

An example method of treatment can include applying a treatment device having actuators to a neurologically disabled limb of a patient, sequentially activating the of actuators to provide a sequence of tactile stimulations to the neurologically disabled limb, and providing the sequence of tactile stimulations to the neurologically disabled limb as part of a rehabilitation treatment for a neurological disorder or other aforementioned condition.

The applied treatment device can include a processor for sequentially activating the actuators, and the actuations of the actuators can be separated by a predetermined temporal offset selected by the processor, and the applied treatment device can be wearable.

The rehabilitation treatment can include providing a sequence of tactile stimulations to a hand, and it can further include providing the sequence of tactile stimulations to the disabled limb while the patent's attention is directed away from the stimulations. Additionally, the rehabilitation treatment can include providing the sequence of tactile stimulations to the disabled limb to neuromuscularly subdue a tremor caused at least in part by the neurological disorder.

The rehabilitation treatment can include providing the sequence of tactile stimulations to the disabled limb for the purpose of inducing motor function improvements in the disabled limb, and the rehabilitation treatment can be directed to treating a disorder resulting at least in part by a stroke and/or brain injury.

The rehabilitation treatment also can include providing the sequence of tactile stimulations to the disabled limb to induce sensory function improvements in the disabled limb, and the rehabilitation treatment can be directed to treating a disorder resulting at least in part by a stroke and/or brain injury. Further, the rehabilitation treatment can include providing the sequence of tactile stimulations to improve Unilateral Spatial Neglect symptoms of a patent having the neurological disorder. Additionally, the rehabilitation treatment can be directed to treating a disorder resulting at least in part by a stroke and/or brain injury.

The rehabilitation treatment can include providing the sequence of tactile stimulations to improve spasticity and muscle tone in the disabled limb, and it can be directed to treating a disorder resulting at least in part by a stroke and/or brain injury.

Another example method for treating a patient can include applying a tactile stimulation device capable of providing a sequence of vibrotactile stimulations to a limb of the patient, and providing the sequence of vibrotactile stimulations by the wearable tactile stimulation device to the limb as part of a rehabilitation treatment for a neurological disorder or other aforementioned condition.

The applied tactile stimulation device can also be capable of providing a second sequence of vibrotactile stimulations that is different from the aforementioned sequence of vibrotactile stimulations, and the tactile stimulation device can provide the second sequence of vibrotactile stimulations as part of the rehabilitation treatment for the neurological disorder.

The applied tactile stimulation device can also be capable of providing two different vibrotactile stimulations at two different locations in the sequence of vibrotactile stimulations, and each of the two different vibrotactile stimulations can have approximately equal time durations.

Additionally, the applied tactile stimulation device can be wearable on a foot or a leg, can be attached to the arm of a chair during at least a portion of the rehabilitation treatment for the neurological disorder, and can be wearable on a hand.

The rehabilitation treatment can include providing the sequence of vibrotactile stimulations by the wearable tactile stimulation device to the limb while muscles of the disabled limb approximate the vibrotactile stimulations are relaxed.

The sequence of vibrotactile stimulations can be provided to rehabilitate a first and a second portion of a limb, such that the first portion of the limb receives stimulations while the second portion of the limb does not receive stimulations, but is nevertheless considered part of the rehabilitation treatment. Also, the sequence of vibrotactile stimulations can be provided to reduce involuntary muscle tone as part of the rehabilitation treatment for the neurological disorder. Further, the sequence of vibrotactile stimulations can be provided by the wearable tactile stimulation device to the limb during out-patient treatment of the neurological disorder as part of the rehabilitation treatment.

Another example method of treatment can include applying a treatment device having actuators, a motion sensor, and a microcontroller to an affected limb of a patient, monitoring, by the microcontroller, a motion signal from the motion sensor, sequentially activating, by the microcontroller, in response to the motion signal, the plurality of actuators to provide a sequence of tactile stimulations to the neurologically disabled limb, and providing the sequence of tactile stimulations to the neurologically affected limb as part of a rehabilitation treatment for tremors resulting from a neurological, cardiovascular, or other aforementioned disorder.

The actuators can be deactivated by the microcontroller in response to the motion signal, and the sequence of tactile stimulations can be provided as part of a rehabilitation therapy for Parkinson's disorder.

Another example method of treatment can include applying a treatment device having actuators to a disabled limb of a patient, sequentially activating the plurality of actuators to provide a sequence of tactile stimulations to the neurologically disabled limb, and providing the sequence of tactile stimulations to the disabled limb as part of a rehabilitation treatment for a stroke.

Another example method of treatment can include applying a treatment device having actuators to a neurologically disabled limb of a patient, sequentially activating the plurality of actuators to provide a sequence of tactile stimulations to the neurologically disabled limb, and providing the sequence of tactile stimulations to the neurologically disabled limb as part of a rehabilitation treatment for a brain injury.

These and other aspects of the present disclosure are described in the Detailed Description below and the accompanying figures. Other aspects and features of embodiments of the present disclosure will become apparent to those of ordinary skill in the art upon reviewing the following description of specific, example embodiments of the present disclosure in concert with the figures. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments of the disclosure discussed herein. In similar fashion, while example embodiments may be discussed below as device, system, or method embodiments, it is to be understood that such example embodiments can be implemented in various devices, systems, and methods of the present disclosure.

### BRIEF DESCRIPTION OF THE SEVERAL VIEWS OF THE DRAWINGS

The above and further aspects of the disclosed technology are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIG. 1 illustrates an example treatment device, according to some embodiments of the present disclosure.

FIG. 2 illustrates example actuator placement, according to some embodiments of the present disclosure.

### DETAILED DESCRIPTION OF THE TECHNOLOGY

The components, steps, and materials described hereinafter as making up various elements of the disclosed technology are intended to be illustrative and not restrictive. Many suitable components, steps, and materials that would perform the same or similar functions as the components, steps, and materials described herein are intended to be embraced within the scope of the disclosed technology. Such other components, steps, and materials not described herein can include, but are not limited to, similar components or steps that are developed after development of the disclosed technology.

The embodiments disclosed herein illustrate devices and methods for providing non-targeted, passive tactile stimulation for functional and sensory recovery from neurological conditions such a stroke. Methods presented herein can generally include using non-focal tactile passive stimulation as part of a rehabilitation treatment following a stroke or a brain injury to induce motor function improvements in the limbs, induce sensory function improvements in the limbs, improve USN symptoms, and/or to improve spasticity and muscle tone symptoms in the limbs. Treatment devices included herein can generally include actuators configured to provide sequential tactile stimulations to the skin of a patent that can be worn or otherwise used in a non-clinical setting. Aspects of embodiments herein in combination with any of the features disclosed herein, other rehabilitation techniques, and/or tactile stimulation devices can provide advantages over current treatments of neurological disorders including increasing accessibility by patients to treatment, providing lower cost treatment options, providing more effective treatments, reducing compliance requirements of treatments, providing treatment options outside of a clinical setting, providing mobile treatment devices, etc.

A treatment device generally can include actuators that can be applied to skin of a patient at a treatment location that can be controlled by a controller to provide stimulation from the actuators as part of a rehabilitation treatment. For example, a device capable of providing a form of tactile stimulation such as from brushes, compression, piezoelectric, or vibratory elements can be adapted to provide tactile stimulation as part of the rehabilitation treatment.

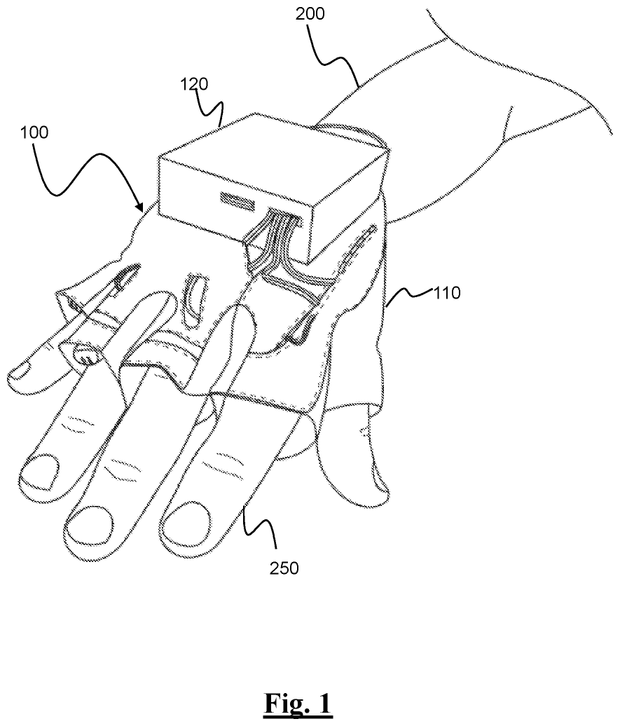

As illustrated in FIG. 1, an example embodiment of a treatment device 100 can include a glove 110 or a pair of gloves (not shown) adapted to include actuators (not shown) in the form of coin vibration motors for producing tactile stimulations in the form of vibrations and electrical circuitry 120 for controlling the actuators. The actuators (not shown) can be positioned on or within the glove 110, and the glove 110 can be worn on a hand 250 of a disabled limb 200, or in the case of treating USN, on the hand 250 of the side of the body affected by USN.

Circuitry 120 can include memory and a processor and can be lightweight and unobtrusively mounted on the glove 110 or otherwise mounted or integrated into the treatment device 100. As illustrated in FIG. 1, circuitry 120 can be positioned on the glove 110 on the back of the hand 250 where the skin is less sensitive.

Circuitry 120 can include computer-readable memory including instructions for controlling the actuators according to embodiments described herein. Additionally, or alternatively, circuitry 120 can include a receiver for receiving instructions for controlling the actuators according to embodiments described herein, the instructions being receivable by wired and/or wireless transmissions. Received instructions can be executed instantaneously or stored locally on the treatment device for repeated or delayed execution. According to some embodiments, circuitry 120 can include sensors for monitoring motion, and the circuitry 120 can be configured to apply treatments based on signals generated by the sensors.

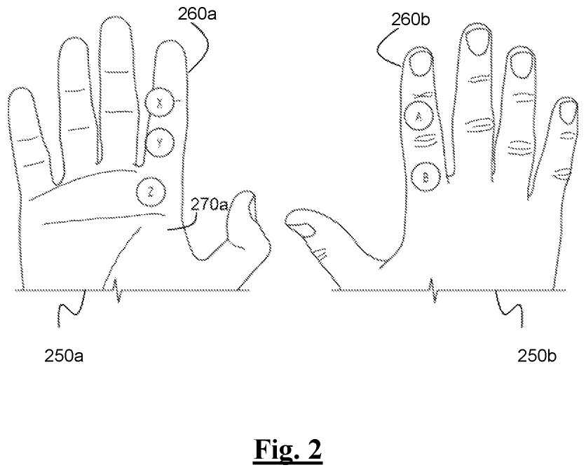

As illustrated in FIG. 2, according to some embodiments, actuators (such as coin vibrators) can be positioned at a number of locations, including those identified as locations X and Y on the inside of a right index finger 260a, location Z on a palm 270a of a right hand 250a, or on the backside of the right index finger 260b of the right hand 250b at locations A and B. The middle, ring, and pinky fingers can be similarly outfitted with actuators, and additional actuators can be included on the palm (not shown). According to some embodiments, one or more vibrating motors can be placed on the dorsal side of the hand at the base of each finger (i.e. on the finger side of the junction where the finger meets the hand, between the joint joining the finger to the hand and the larger finger knuckle). Such placement can provide out-of-the way placement of the vibrating motors so that patient is uninhibited by the treatment when performing most daily activities while receiving treatments throughout the day in a body region with a relatively high concentration of sensory receptors.

According to some embodiments, choice of stimulation actuators, placement of actuators, durations of sequential stimulations, and intensity of stimulations can be determined to provide enough stimulation to an entire intended treatment area of a disabled limb. A strategy can include having independently activated “zones” such as an actuator for each finger. The zones can be determined such that sufficient distance exists between the stimulation locations to enable discrete perception of each stimulation, i.e. to prevent effects such as funneling or habituation.

In some example embodiments, a treatment device can be battery operated and can include an integrated battery. The battery can be recharged from an outlet, computer, power bank or the like. The battery and charging system can be constructed from known batteries and chargers like those used in tablets, computers, phones, and other portable electronic devices. The treatment device can therefore be cordless.

Example treatment devices can generally be designed for usability in consideration of mobility-challenged, disabled stroke patients or patients recovering from brain damage. Example treatment devices can generally be designed to be usable on-the-go or at home. Rehabilitation therapies involving the treatment device can require the patient to wear the treatment device and receive the tactile stimulation from the treatment device without requiring any further exercise or therapy, resulting in a low effort rehabilitation therapy regime.

Example treatment devices can further include sensors for monitoring treatment and can adapt tactile stimulation in response to signals and/or data gathered from the sensors. According to some embodiments, treatment devices can include a motion sensor such as an accelerometer or a gyroscope and a clock for recording when, and for how long a patient received treatment from the device. Devices for treatment of Parkinson's can be configured to sense tremors and activate vibrators or other sensory actuators when the tremor is present. Tremors in the hand or arm can be sensed by a treatment device worn as a sleeve and/or glove, and actuators can provide stimulation to the hand or arm. Therefore, tremors can be treated without continuously applying sensory stimulation to the satisfaction of some patents and with the potential benefit of improving battery life of the treatment device. Non-continuous treatment can also preserve the effect from adaptation. According to some embodiments, a treatment device including a motion sensor can be similarly adapted to sense a level of spasticity in the hand (or other body location to which the treatment device is applied) of a patient (such as a stroke patient) and turn on or off stimulations as appropriate.

According to some embodiments, treatment devices including one or more motion sensors can be adapted to sense and record user conditions for customized therapy. For example, treatment devices can record a patient's range of motion or adherence to wearing the treatment device, and the recorded patient activities can be used by a therapist or the patient to monitor and potentially modify a rehabilitation treatment. Recorded patient activities can also be analyzed algorithmically to provide further information for monitoring and/or modifying the rehabilitation treatment.

Example treatment devices can be shipped via traditional means as for other portable electronic devices. A treatment device can be prescribed as part of a rehabilitation treatment for treating a patient suffering from a neurological disorder. The treatment device can be prescribed as part of a rehabilitation treatment following a stroke or a brain injury to induce motor function improvements in the limbs, induce sensory function improvements in the limbs, improve USN symptoms, and/or to improve spasticity and muscle tone symptoms in the limbs. The treatment device can be loaned or purchased (e.g., similar to how Holter monitors and other medical treatment devices are loaned or purchased).

Example treatment devices can provide subtle, non-focal vibration. Example treatment devices can provide passive stimulation on-the-go or at home rehabilitation therapy treatment for neurological disorders. Example treatment devices can be low-cost, lightweight, mobile, cordless, and/or wearable. Example treatment devices can provide tactile stimulation, a form of stimulation not currently provided in known, clinically accepted forms of neurological disorder rehabilitation therapy. Example treatment devices can provide noninvasive rehabilitation therapy for treating neurological disorders. According to some example embodiments, muscles that are either tense or relaxed can be stimulated as part of a rehabilitation treatment of a neurological disorder. A patient undergoing treatment can be in any position performing virtually any daily activity. Rehabilitation therapy can include passive therapy wherein active effort or attention on the part of the patient is not required. Example treatment devices can be effective for neurological disorder rehabilitation without the need for electrodes for electrostimulation or gel. Example rehabilitation treatments need not include electrostimulation. According to some example embodiments, rehabilitation treatment for a neurological disorder need not involve exercise of an affected limb or restrain of a dominant limb.

According to some example embodiments, treatment of a location such as the hand, can be effective as a rehabilitation treatment for a non-targeted muscle such as the arm, elbow, shoulder, or as a treatment for USN. According to some example embodiments, treatments presented herein need not be combined with modalities involving electrostimulation nor muscle contraction to be effective as a rehabilitation treatment. According to some example embodiments, treatments presented herein need not involve any specific muscular manipulation of a limb (such as is employed in CIMT).

According to some example embodiments, treatment devices can be worn, or a treatment device can be placed in contact with the skin of the patient. Actuators can be incorporated into, attached to, or otherwise used in combination with a stationary device such as the arm rest of a chair to form a treatment device. Small vibration motors or other actuators can be sewn into a fabric of the treatment device or can be otherwise integrated into the treatment device. Additionally, or alternatively actuators can be mounted or positioned on a surface of the treatment device.

According to some example embodiments, non-focal vibration or other tactile stimulation can be applied to the surface of the skin as part of a rehabilitation treatment for improving motor functions in a limb disabled following a stroke or other brain injury. Rehabilitation treatments wherein the patient receives tactile stimulations from a treatment device by wearing or resting against the treatment device can be effective for improving motor functions in the disabled limb without the need for performing any additional exercise or therapy during the rehabilitation treatment. Rehabilitation treatments wherein the patient receives tactile stimulations from a treatment device by wearing or resting against the treatment device can be effective for improving motor functions in the disabled limb without the need for the patient to be actively paying attention to the tactile stimulations.

According to some example embodiments, non-focal vibration or other tactile stimulation can be applied to the surface of the skin as part of a rehabilitation treatment for improving and at least partially restoring tactile sensation in an affected area of skin such as on a disabled limb following a stroke or other brain injury. Rehabilitation treatments wherein the patient receives tactile stimulations from a treatment device by wearing or resting against the treatment device can be effective for improving and at least partially restoring tactile sensation in the affected area of skin without the need for performing any additional exercise or therapy (including electrotherapy) during the rehabilitation treatment. Rehabilitation treatments wherein the patient receives tactile stimulations from a treatment device by wearing or resting against the treatment device can be effective for improving and at least partially restoring tactile sensation in the affected area of skin without the need for the patient to be actively paying attention to the tactile stimulations. Sensory abilities that can be improved include cutaneous sensation as well as proprioception and Kinesthetic awareness. Rehabilitation treatments specifically designed for improving and at least partially restoring tactile sensation can also be affective at restoring motor function, even if the rehabilitation treatment is not specifically designed for such purpose or directed toward improving functionality of a targeted muscle. A combination rehabilitation treatment for both improving tactile stimulation and motor functions can be affecting for improving protective sensation following injuries from burns, hyper-extension, cuts, and other such ailments, and to prevent further injury due to those ailments.

According to some example embodiments, non-focal vibration or other tactile stimulation can be applied to the surface of the skin as part of a rehabilitation treatment for sensory neglect intervention such as USN following a stroke or other brain injury. In general, USN is a problem with attention. Patients are unable to focus on their left or right field of view (i.e. “Dad can't drive anymore after his stroke because he ignores signs on his left side”). According to some example embodiments, rehabilitation treatments wherein the patient receives tactile stimulations from a treatment device by wearing or resting against the treatment device can be effective for improving and at least partially restoring attention to the side of the patent affected by USN without the need for performing any additional therapy (i.e. treatment strategies involving forcing the patient to pay attention to the affected side or targeted neck muscle stimulation) during the rehabilitation treatment. Rehabilitation treatments wherein the patient receives tactile stimulations from a treatment device by wearing or resting against the treatment device can be effective for improving and at least partially restoring attention to the side of the patent affected by USN without the need for the patient to be actively paying attention to the tactile stimulations.

According to some example embodiments, non-focal vibration or other tactile stimulation can be applied to the surface of the skin as part of a rehabilitation treatment for muscle tone reduction in involuntarily contracting muscles following a stroke or other brain injury. In general, after a stroke or brain injury, some muscles lose control and some involuntarily contract. The imbalance creates spasticity/“tone” and can cause tightness in joints and limbs. Tone can be very common in stroke survivors and can often be severe enough to make it difficult for a patient to stretch open hands and limbs. According to some example embodiments, rehabilitation treatments wherein the patient receives tactile stimulations from a treatment device by wearing or resting against the treatment device can be effective for muscle tone reduction in involuntarily contracting muscles without the need for performing any additional exercise, stretching, Botox injections, muscle relaxers, medications such as Baclofen, or other therapy or intervention during the rehabilitation treatment. Rehabilitation treatments wherein the patient receives tactile stimulations from a treatment device by wearing or resting against the treatment device can be effective muscle tone reduction in involuntarily contracting muscles without the need for the patient to be actively paying attention to the tactile stimulations.

In some embodiments, a treatment device can be configured to generate a sequence of stimulations from the actuators. The treatment device can include a memory or can be otherwise in communication with the memory, the sequence of stimulations can be stored in memory, the sequence can be read from memory by a processor, and the processor can provide control signals to actuate the actuators according to the sequence to generate the sequence of stimulations. The stimulation sequence stored in memory can include instructions activating one or more of the actuators in a particular sequence. The treatment device can further store multiple stimulation sequences, and can repeat each stimulation sequence, and/or alternate between stimulation sequences. In some applications, periodically or spontaneously changing from one stimulation sequence to another can reduce the likelihood that a patent becomes desensitized to a particular stimulation sequence, and can thereby improve the effectiveness of a rehabilitation treatment.

In some embodiments, a processor of a computing device can generate a plurality of stimulation sequences. According to some embodiments, each stimulation sequence and the resulting sequential activation of one or more of the actuators can provide a tactile stimulation sequence to the skin of a patent, for example to the skin of a neurologically disabled limb. According to some embodiments, the stimulation sequence can include a temporal offset between the onset of stimulations within the sequence such that each stimulation within the sequence is independently but perceptible. For example, subsequent activations of two different actuators can be separated by a predetermined temporal offset, which could be between about 5 milliseconds and 50 milliseconds to create independently perceptible stimulations that are perceived as essentially simultaneous stimulations. Additionally, or alternatively, subsequent activations of two different actuators, a single actuator, or a group of actuators activated to produce simultaneously stimulation can be separated by a longer predetermined temporal offset, for example 120 milliseconds that are perceived essentially as discrete taps. It will be understood thereby those skilled in the art that there can be more than one predetermined temporal offset, or the value of the offset can change from one embodiment to the next as independent perception is not only a function of the temporal offset but also the placement of the actuators, intensity of the stimulation, and physiological condition of the treatment area of the patient. Alternatively, or additionally, the stimulation sequence can include one or more overlapping stimulations, the overlapping stimulations not being independently perceptible.

In some embodiments, stimulation patterns can be engineered for even coverage, i.e. even distribution of stimulations over a treatment area and even activation such that each stimulation location is activated for an approximately equal amount of time compared to every other stimulation location. For treatments provided by a glove, for example, if all five fingers of a patient are affected, each of the fingers can receive about the same amount of stimulation. According to some embodiments, stimulations can have a random distribution while maintaining even coverage. The random distribution can reduce the likelihood that the treatment becomes ineffective due to the patient adapting to the stimulation.

In some embodiments, actuators can be placed on multiple parts of the body. Each body part can be stimulated as part of a stimulation sequence. The stimulation sequence can include temporal offsets for simultaneous independent perception, discrete tap perception, some combination thereof, or some combination that includes other temporal offset strategies.

In some embodiments, however, stimulation can be applied to a specific body part. For example, stimulation can be applied on the neck (e.g., a vibrating motor can be placed in an LG Tone Pro wearable or similar device). Similarly, in some embodiments, stimulation can be applied to the foot (e.g., vibrating motors can be placed in an ankle bracelet). Likewise, in some embodiments, stimulation can be applied to the waist (e.g., vibrating motors can be embedded in a belt). Finally, in some embodiments, stimulation can be applied to the thigh (e.g., vibrating motors can be sewn into a garment such as a garter belt, for example).

As discussed above, existing rehabilitation treatments of neurological disorders rely primarily of focused muscle manipulation and do not rely on tactile stimulation. Common wisdom would therefore not suggest that any form of tactile stimulation would be effective at treating neurological disorders, let alone stimulation that is not applied to a specific muscle or treatment area that can benefit from such treatment, or stimulation that can be effective absent the patent's active attention and involvement.

Aspects of the various example embodiments described herein can potentially be explained by exploring the anatomy of tactile sensation and phenomena in tactile perception.

It is possible that, when exposed to a seemingly random set of stimulation on the skin, the brain devotes an increasing number of neurons to help in understanding the signal. Thus, while an affected hand might normally go unused in a stroke patient and provide little input to the brain because of its disuse, the stimulation “reminds” the brain of the presence of the limb. Stimulation in the somatosensory region of the brain can cause sympathetic stimulation in the motor cortex related to that same area. Thus, the stimulation can cause both an increase in neurons devoted to sensation and dexterity to the region. The issue of spasticity in the arm likely relates to an abnormal feedback loop between sensation and control in the brain. By improving sensation and dexterity, it is possible to improve the feedback loop to the affected area and improve tone, causing a loosening of the contracted muscles, for example in a clubbed hand.

For Parkinson's, it is possible that stimulation of the arm performs a function like that of a deep brain stimulator (DBS). A DBS can be thought of as a pacemaker for the brain. A Parkinsonian (pill-rolling) tremor is caused by random firing of the neurons in the region that controls the arm. A DBS stimulates that region causing the neurons to fire in synchrony with the DBS, exhausting the excess energy in the neurons. By stimulating the arm with vibration, it is possible to create a similar pacing signal which can cause the neurons in the region to fire regularly, consuming the excess energy in the region, resulting in less random firing and less tremor.

It is also possible that sensory stimulation can cause an abundance of coactivation of the nervous system of a treated limb or body part, and therefore the increased sensory stimulation simulates, in the brain, similar functions as occur in the brain during exercise.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specifically, it is to be understood that methods presented herein can be carried out by example treatment devices presented herein or by any other device capable of functioning as a treatment device as claimed. Actuators need not be limited to coin vibration motors, and any number of stimulators could be used to provide tactile inputs such as other vibratory elements, brushes, compression devices, compressed air release devices, or piezoelectric devices, etc. The treatment device need not be a glove and can be a band, sleeve, boot, cap, brace, necklace, or have any other such wearable form. The treatment device need not be wearable—for example, actuators could be incorporated into the arm of a chair, in a handheld device, or in a pad or blanket. The actuators and associated controlling circuitry need not be incorporated into the same device—for example, a treatment device can be in communication with a computer, smart phone, or other auxiliary device that is capable of communicating with the treatment device to control the actuators. Methods of treatment presented herein can further be combined with known or otherwise available treatments. Method of treatment presented herein can provide further benefits not listed herein, and could be applicable to treatment of diseases not described herein as would be appreciated and understood by a person of ordinary skill in the art.

Various aspects described herein can be implemented using standard engineering techniques to produce software, firmware, hardware, or any combination thereof to control a treatment device to implement the disclosed subject matter. A computer-readable medium can include, for example: a hard disk, solid state drive, optically readable disk, or other known medium. It should be appreciated that a treatment device can be configured to receive said computer-readable medium via wired or wireless transmission means and the treatment device itself need not include the computer-readable medium to carry out aspects of rehabilitation treatments described herein.

It is to be understood that the phraseology and terminology employed herein are for the purposes of description and should not be regarded as limiting the claims. Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. Instead, it is intended that the disclosed technology is defined by the claims appended hereto.

1. A method of treatment comprising:
applying a treatment device comprising actuators to a neurologically disabled limb of a patient;
sequentially activating the actuators to provide a sequence of tactile stimulations to the neurologically disabled limb; and
providing the sequence of tactile stimulations to the neurologically disabled limb as part of a rehabilitation treatment for a neurological disorder.

2. The method of claim 1, wherein sequentially activating the actuators to provide the sequence of tactile stimulations to the disabled limb further comprises sequentially activating, with a predetermined temporal offset between sequential activations, the actuators in a sequential order.

3. The method of claim 1 further comprising providing at least a portion of the sequence of tactile stimulations to a hand as part of the rehabilitation treatment for the neurological disorder.

4. The method of claim 1, wherein the treatment device is wearable.

5. The method of claim 1 further comprising providing at least a portion of the sequence of tactile stimulations to the neurologically disabled limb of a patient while the patent's attention is directed away from the at least a portion of the sequence of tactile stimulations as part of the rehabilitation treatment for a neurological disorder.

6. The method of claim 1 further comprising providing the sequence of tactile stimulations to neuromuscularly subdue a tremor caused at least in part by the neurological disorder.

7. The method of claim 1 further comprising providing the sequence of tactile stimulations for the purpose of inducing motor function improvements in the disabled limb as part of the rehabilitation treatment for the neurological disorder, the neurological disorder resulting at least in part by a stroke and/or brain injury.

8. The method of claim 1 further comprising providing the sequence of tactile stimulations to induce sensory function improvements in the disabled limb as part of the rehabilitation treatment for the neurological disorder, the neurological disorder resulting at least in part by a stroke and/or brain injury.

9. The method of claim 1 further comprising providing the sequence of tactile stimulations to improve Unilateral Spatial Neglect symptoms of a patent having the neurological disorder as part of the rehabilitation treatment for the neurological disorder, the neurological disorder resulting at least in part by a stroke and/or brain injury.

10. The method of claim 1 further comprising providing the sequence of tactile stimulations to improve spasticity and muscle tone in the disabled limb as part of the rehabilitation treatment for the neurological disorder, the neurological disorder resulting at least in part by a stroke and/or brain injury.

11.-12. (canceled)

13. A method of treatment comprising:
providing a first sequence of vibrotactile stimulations at a first location of a limb of a patient as part of a rehabilitation treatment for a neurological disorder;
providing a second sequence of vibrotactile stimulations at a second location different from the first location;
providing the first vibrotactile stimulation for a first time period; and
providing the second vibrotactile stimulation for a second time period.

14. The method of claim 13 further comprising providing a wearable tactile stimulation configured to provide the sequences of vibrotactile stimulations.

15. The method of claim 14, wherein the wearable tactile stimulation device is attached to the arm of a chair during at least a portion of the rehabilitation treatment for the neurological disorder.

16. The method of claim 14, wherein the wearable tactile stimulation device is wearable on a hand.

17. The method of claim 14 further comprising providing the sequences of vibrotactile stimulations by the wearable tactile stimulation device to the limb while muscles of the limb approximate the vibrotactile stimulations are relaxed as part of the rehabilitation treatment for the neurological disorder.

18. (canceled)

19. The method of claim 14, wherein providing the sequences of vibrotactile stimulations reduce involuntary muscle tone as part of the rehabilitation treatment for the neurological disorder.

20. The method of claim 14, wherein providing the sequences of vibrotactile stimulations occur during out-patient treatment of the neurological disorder as part of the rehabilitation treatment.

21. A method of treatment comprising:
applying to a neurologically affected limb of a patient a treatment device comprising:
actuators;
a motion sensor; and
a microcontroller;
monitoring, by the microcontroller, a motion signal from the motion sensor;
sequentially activating, by the microcontroller, in response to the motion signal, the actuators to provide a sequence of tactile stimulations to the neurologically affected limb; and
providing the sequence of tactile stimulations to the neurologically affected limb as part of a rehabilitation treatment.

22. The method of claim 21 further comprising deactivating, by the microcontroller, in response to the motion signal, the actuators.

23. The method of claim 21 further comprising providing the sequence of tactile stimulations as part of a rehabilitation therapy for Parkinson's disorder.

24.-27. (canceled)
